(19) United States
(12) Patent Application Publication
(10) Pub. No.: US 2024/0213447 A1
(43) Pub. Date: Jun. 27, 2024

(54) POSITIVE ELECTRODE PLATE FOR NON-AQUEOUS ELECTROLYTE RECHARGEABLE BATTERY, NON-AQUEOUS ELECTROLYTE RECHARGEABLE BATTERY, AND METHOD FOR MANUFACTURING POSITIVE ELECTRODE PLATE FOR NON-AQUEOUS ELECTROLYTE RECHARGEABLE BATTERY

(71) Applicants: PRIMEARTH EV ENERGY CO., LTD., Kosai-shi, Shizuoka (JP); TOYOTA JIDOSHA KABUSHIKI KAISHA, Toyota-shi, Aichi-ken (JP); PRIME PLANET ENERGY & SOLUTIONS, INC., Tokyo (JP)

(72) Inventor: Shotaro DEGUCHI, Toyohashi-shi (JP)

(73) Assignees: PRIMEARTH EV ENERGY CO., LTD., Kosai-shi, Shizuoka (JP); TOYOTA JIDOSHA KABUSHIKI KAISHA, Toyota-shi, Aichi-ken (JP); PRIME PLANET ENERGY & SOLUTIONS, INC., Tokyo (JP)

(21) Appl. No.: 18/231,169

(22) Filed: Aug. 7, 2023

(30) Foreign Application Priority Data
Aug. 10, 2022 (JP) 2022-128380

(51) Int. Cl. H01M 4/139; H01M 4/04; H01M 4/62; H01M 10/0525; H01M 4/02

(52) U.S. Cl. CPC H01M 4/139; H01M 4/0404; H01M 4/0471; H01M 4/625; H01M 10/0525; H01M 2004/021; H01M 2004/028

(57) ABSTRACT

A positive electrode plate for a non-aqueous electrolyte rechargeable battery includes a positive electrode mixture layer that is formed by a positive electrode mixture including a positive electrode active material and a conductive material. When R_{S}=(R_{C}×B_{C})/(R_{A}×B_{A}) is satisfied, where R_{C} (mass %) represents a percentage of the conductive material, B_{C} (m²/g) represents a specific surface area of the conductive material, R_{A} (mass %) represents a percentage of the positive electrode active material, B_{A} (m²/g) represents a specific surface area of the positive electrode active material, and R_{S} represents a total surface area ratio, an aspect ratio AR of the conductive material is thirty or greater, the total surface area ratio R_{S} is in a range of 0.20 to 1.93, and a porosity P (%) of the positive electrode mixture layer is in a range of 40% to 55%.

### BACKGROUND

### 1. Field

The following description relates to a positive electrode plate for a non-aqueous electrolyte rechargeable battery, a non-aqueous electrolyte rechargeable battery, and a method for manufacturing a positive electrode plate for a non-aqueous electrolyte rechargeable battery, and more particularly, a positive electrode plate for a non-aqueous electrolyte rechargeable battery, a non-aqueous electrolyte rechargeable battery, and a method for manufacturing a positive electrode plate for a non-aqueous electrolyte rechargeable battery in which the percentage of a conductive material is optimized.

### 2. Description of Related Art

A positive electrode plate of a non-aqueous electrolyte rechargeable battery includes a positive electrode active material in a positive electrode mixture layer. The positive electrode active material produces the main reaction of the battery. Since the conductivity of the positive electrode active material is not high enough on its own, a conductive material is added to the positive electrode active material to increase the conductivity between a non-aqueous electrolyte and the positive electrode active material. Then, a binder including a binding agent and a viscosity modifier is mixed with the positive electrode active material so as to fix the positive electrode active material to a positive electrode current collector. The positive electrode current collector serves as a substrate formed by a metal foil or the like. The positive electrode active material, the conductive material, the binder, and a solvent are kneaded into a paste. Such a paste is applied to the positive electrode current collector, or the substrate, in a coating step. After the coating, the paste is dried to remove the solvent so that the solid content fixed to the substrate forms a positive electrode mixture layer. The positive electrode mixture layer is then pressed and shaped to have a uniform thickness in a pressing step.

The amount of reaction occurring in the battery depends on the surface area of the positive electrode active material, which produces the main reaction of the battery. Thus, it is desirable that the positive electrode active material have a large specific surface area. On the other hand, it is also necessary to ensure sufficient surface area of the conductive material in order to increase the conductivity of the electrode mixture layer. However, if the amount of the conductive material added to the positive electrode active material becomes too large, the percentage of the positive electrode active material decreases. This also decreases the percentage of the surface area of the positive electrode active material, thereby reducing the battery performance qualities. Accordingly, the balance between the surface area (m²) of the positive electrode active material and the surface area (m²) of the conductive material is an important element in determining the percentages of the positive electrode active material and the conductive material.

Japanese Laid-Open Patent Publication No. 2011-129442 describes an invention in which a positive electrode includes a positive electrode active material having a high potential of 4.5V or greater on the basis of metallic lithium, and a conductive agent including hard carbon and carbon black. The positive electrode is configured such that a ratio (SC)/(SA) of a surface area (SC) of the conductive agent to a surface area (SA) of the positive electrode active material in a positive electrode mixture is in a range of 0.5 to 2.5.

Further, Japanese Laid-Open Patent Publication No. 2010-205430 describes an invention in which lithium iron phosphate serving as a positive electrode active material has a Brunauer-Emmett-Teller (BET) specific surface area set in a range of 5 to 30 m²/g. When the surface area of the lithium iron phosphate is represented by one, a total sum of surface areas of three types of carbon materials included in the positive electrode active material is adjusted to be in a range of 0.1 to 1.2, where the surface area of each carbon material is the product of a corresponding weight and a corresponding BET specific surface area.

The examples above optimize the percentages of the positive electrode active material and the conductive material by controlling the surface area of the positive electrode plate.

### SUMMARY

Although the specific surface area of the positive electrode plate is an important element in determining the percentage of the conductive material, an ideal electrode state (best performance quality) cannot be obtained by merely controlling the specific surface area of the positive electrode. The electrode state is also affected by the type of the conductive material, the porosity of the electrode, and the like.

An objective of the present disclosure is to optimize the percentage of a conductive material included in a positive electrode plate for a non-aqueous electrolyte rechargeable battery.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a positive electrode plate is for a non-aqueous electrolyte rechargeable battery. The battery includes a positive electrode plate, a negative electrode plate, a separator insulating the positive electrode plate and the negative electrode plate, and a non-aqueous electrolyte. The positive electrode plate includes a positive electrode current collector and a positive electrode mixture layer. The positive electrode mixture layer is formed on a part of at least one surface of the positive electrode current collector and formed by a positive electrode mixture. The positive electrode mixture includes a positive electrode active material and a conductive material. When R_{S}=(R_{C}×B_{C})/(R_{A}× B_{A}) is satisfied, where R_{C} (mass %) represents a percentage of the conductive material in the positive electrode mixture, B_{C} (m²/g) represents a specific surface area of the conductive material, R_{A} (mass %) represents a percentage of the positive electrode active material in the positive electrode mixture, B_{A} (m²/g) represents a specific surface area of the positive electrode active material, and R_{S} represents a total surface area ratio, an aspect ratio AR of the conductive material is thirty or greater. Further, the total surface area ratio R_{S} is in a range of 0.20 to 1.93. Furthermore, a porosity P (%) of the positive electrode mixture layer is in a range of 40% to 55%.

With the above positive electrode plate, the specific surface area B_{A} (m²/g) of the positive electrode active material may be in a range of 1.6 to 3.3 m²/g. The specific surface area B_{C} (m²/g) of the conductive material may be in a range of 180 to 500 m²/g. The percentage R_{C} (mass %) of the conductive material in the positive electrode mixture may be in a range of 0.2 to 1.5 mass %.

With the above positive electrode plate, the positive electrode mixture layer may be divided in a thickness-wise direction of the positive electrode mixture layer into two regions, a separator region located closer to the separator, and a positive electrode current collector region located closer to the positive electrode current collector. A mass M_{UP} (g) of the conductive material present in the separator region of the positive electrode mixture layer may be greater than a mass M_{LOW} (g) of the conductive material present in the positive electrode current collector region of the positive electrode mixture layer.

With the above positive electrode plate, a conductive material upper-lower ratio R_{M} may be in a range of 1.5 to 20, where the conductive material upper-lower ratio R_{M} is a mass ratio of the mass M_{UP} (g) of the conductive material present in the separator region of the positive electrode mixture layer to the mass M_{LOW} (g) of the conductive material present in the positive electrode current collector region of the positive electrode mixture layer.

With the above positive electrode plate, a porosity P_{LOW} (%) of the positive electrode current collector region of the positive electrode mixture layer may be greater than a porosity P_{UP} (%) of the separator region of the positive electrode mixture layer.

With the above positive electrode plate, a porosity upper-lower ratio R_{P} may be in a range of 1.1 to 12, where the porosity upper-lower ratio R_{P} is a ratio of the P_{LOW} (%) of the positive electrode current collector region of the positive electrode mixture layer to the P_{UP} (%) of the separator region of the positive electrode mixture layer.

In another general aspect, a non-aqueous electrolyte rechargeable battery may include the above positive electrode plate for a non-aqueous electrolyte rechargeable battery.

In another general aspect, a method is for manufacturing a positive electrode plate for a non-aqueous electrolyte rechargeable battery. The battery includes a positive electrode plate, a negative electrode plate, a separator insulating the positive electrode plate and the negative electrode plate, and a non-aqueous electrolyte. The positive electrode plate includes a positive electrode current collector and a positive electrode mixture layer. The positive electrode mixture layer is formed on a part of at least one surface of the positive electrode current collector and formed by a positive electrode mixture. The positive electrode mixture includes a positive electrode active material and a conductive material. The method includes preparing a positive electrode mixture paste, applying the positive electrode mixture paste to a part of at least one surface of the positive electrode current collector, and drying the positive electrode mixture paste to form the positive electrode mixture layer. The preparing a positive electrode mixture paste is performed so that when R_{S}=(R_{C}×B_{C})/(R_{A}× B_{A}) is satisfied, where R_{C} (mass %) represents a percentage of the conductive material in the positive electrode mixture, B_{C} (m²/g) represents a specific surface area of the conductive material, R_{A} (mass %) represents a percentage of the positive electrode active material in the positive electrode mixture, B_{A} (m²/g) represents a specific surface area of the positive electrode active material, and R_{S} represents a total surface area ratio, an aspect ratio AR of the conductive material is thirty or greater. Further, the total surface area ratio R_{S} is in a range of 0.20 to 1.93. Furthermore, a porosity P (%) of the positive electrode mixture layer is in a range of 40% to 55%.

With the above method, where the positive electrode mixture layer being divided in a thickness-wise direction of the positive electrode mixture layer into two regions, a separator region located closer to the separator, and a positive electrode current collector region located closer to the positive electrode current collector, the preparing a positive electrode mixture paste may include adjusting a solid content ratio NV of the positive electrode mixture paste, and the drying the positive electrode mixture paste may include controlling a drying temperature and a drying time period. In this case, a conductive material upper-lower ratio R_{M} after the drying is in a range of 1.5 to 20, where the conductive material upper-lower ratio R_{M} is a mass ratio of a mass M_{UP} (g) of the conductive material present in the separator region of the positive electrode mixture layer to a mass M_{LOW} (g) of the conductive material present in the positive electrode current collector region of the positive electrode mixture layer. Further, a porosity upper-lower ratio R_{P} is in a range of 1.1 to 12, where the porosity upper-lower ratio R_{P} is a ratio of a porosity P_{LOW} (%) of the positive electrode current collector region of the positive electrode mixture layer to a porosity P_{UP} (%) of the separator region of the positive electrode mixture layer.

Other features and aspects will be apparent from the following detailed description, the drawings, and the claims.

### BRIEF DESCRIPTION OF THE DRAWINGS

FIG. 1 is a perspective view schematically showing the structure of a lithium-ion rechargeable battery in accordance with the present embodiment.

FIG. 2 is a diagram schematically showing the structure of a roll of an electrode body in accordance with the present embodiment.

FIG. 3A shows a relationship between particles of a positive electrode active material, a conductive material, and a non-aqueous electrolyte when a porosity P is high and an aspect ratio AR is small. FIG. 3B shows a relationship between the particles of the positive electrode active material, a fibrous conductive material, and the non-aqueous electrolyte when the porosity P is high and the aspect ratio AR is high. FIG. 3C shows a relationship between the particles of the positive electrode active material, the conductive material, and the non-aqueous electrolyte when the porosity P is low.

FIG. 4 is a flowchart illustrating steps of a positive electrode plate manufacturing process.

FIG. 5A is a diagram schematically showing a front-surface positive electrode mixture paste application step of the positive electrode plate manufacturing process. FIG. 5B is a diagram schematically showing a first drying step of the positive electrode plate manufacturing process. FIG. 5C is a diagram schematically showing a back-surface positive electrode mixture paste application step of the positive electrode plate manufacturing process.

FIG. 6 is a table showing the results of Experimental Example 1.

FIG. 7 is a table showing the results of Experimental Example 2.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

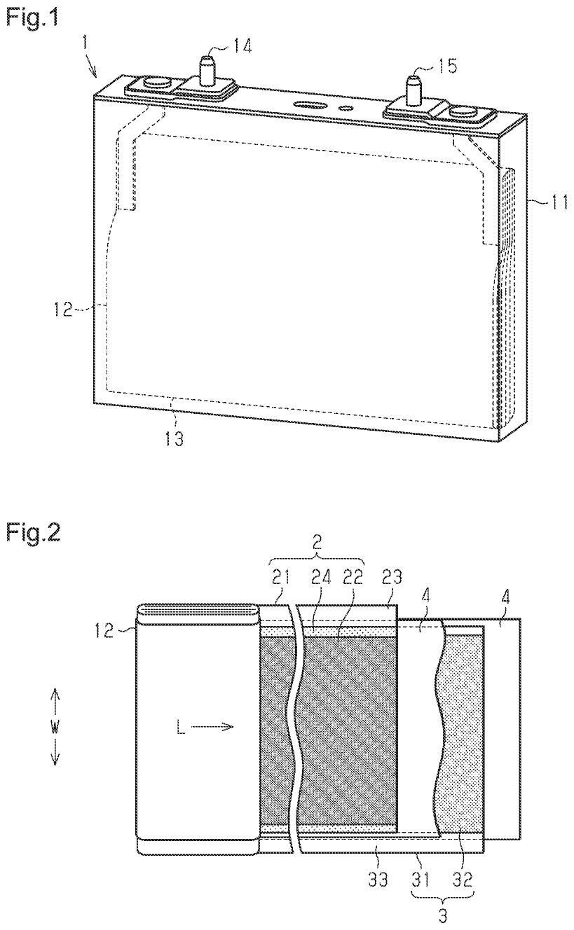

A positive electrode plate for a non-aqueous electrolyte rechargeable battery, a non-aqueous electrolyte rechargeable battery, and a method for manufacturing a positive electrode plate for a non-aqueous electrolyte rechargeable battery in accordance with the present disclosure will now be described with an embodiment of a lithium-ion rechargeable battery 1 and a method for manufacturing and a positive electrode plate 2 of the lithium-ion rechargeable battery 1 with reference to FIGS. 1 to 7.

### Definitions

Definitions of the terms used in the present embodiment will be described below.

Specific Surface Area (m²/g)

The specific surface area (m²/g) refers to an area (m²) per unit mass (g). The specific surface area may be measured by an adsorption method, a wetting-heating method, a chemical reaction method, or the like. The adsorption method includes a Brunauer-Emmett-Teller (BET) method, a Langmuir method, or the like.

In the present embodiment, a widely known BET method (gas adsorption method) is used to obtain a specific surface area of the particles of a positive electrode active material and a specific surface area of the particles of a conductive material, which are included in a positive electrode mixture layer. Specifically, for example, QUANTASORB® manufactured by Quanta Chrome was used as a BET specific surface area measuring device, and an adsorption gas was nitrogen gas. When krypton is used as the adsorption gas, smaller samples can be used for the measurements as compared to when nitrogen gas is used. A bulk solid cell was used as a sample cell, and a sample containing the particles of a positive electrode active material and the particles of the conductive material was rolled and set in the cell for measurement.

In the present embodiment, a value of BET (m²/g) that is measured in the manner described above is referred to as a specific surface area B (m²/g). The specific surface area (m²/g) of a positive electrode active material 22b is referred to as a positive electrode active material specific surface area B_{A} (m²/g). The specific surface area (m²/g) of a conductive material 22c is referred to as a conductive material specific surface area B_{C} (m²/g).

### Surface Area S (m²)

The surface area S (m²) may be measured by the above-described BET specific surface area measuring device. Alternatively, the surface area S (m²) may be obtained from a mass (g) based on the BET value.

The surface area of the positive electrode active material 22b included in an entire positive electrode mixture layer 22, which is obtained in the manner described above, is represented by S_{A} (m²). The surface area of the conductive material 22c included in the entire positive electrode mixture layer 22 is represented by S_{C} (m²).

### Porosity P (%)

Porosity P (%) is a scale indicating the volume of pores such as voids between particles. Porosity P (%) is generally proportional to a coefficient of water permeability. Thus, in the present embodiment, porosity P (%) is used as an index of an efficiency at which a non-aqueous electrolyte 13 flows through the positive electrode mixture layer 22 in a cell.

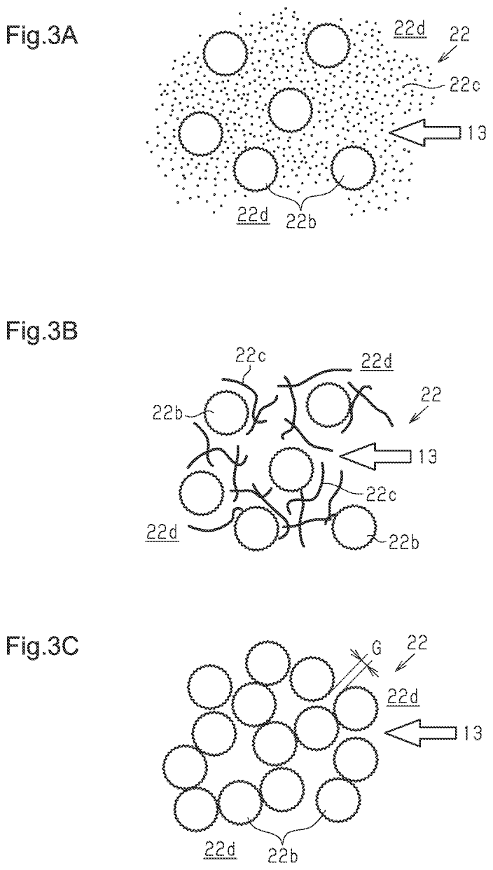

As shown in FIG. 3C, porosity P (%) also serves as an index of a gap G between the particles of the positive electrode active material 22b in the positive electrode mixture layer 22.

Porosity P (%) is measured by, for example, a liquid immersion method in which a porous sample is immersed in a liquid having a high wettability to saturate the pores with the liquid. Porosity P (%) may be measured by an optical method in which microscopic observation is conducted on a cross section of a sample to determine an area of the material and an area of the visible voids. Further, porosity P (%) may be measured by, for example, mercury porosimetry in which an amount of mercury, having a high surface tension, injected into fine pores of a sample is measured with respect to an externally applied pressure so as to obtain the distribution and volume of the pores.

### Average Diameter

In the present embodiment, the term “average diameter” means a median diameter (D50: 50% volume average particle diameter) that corresponds to 50% accumulation in a volume-based particle size distribution, unless specified otherwise. This applies to other instances of use of “average”. A laser diffraction and light scattering method may be used to obtain the average diameter in a range in which the average particle diameter is approximately 1 μm or greater. A dynamic light scattering (DLS) method may be used to obtain the average particle diameter in a range in which the average particle diameter is approximately 1 μm or less. The average particle diameter obtained by the DLS method may be measured in accordance with JISZ8828:2013.

### Aspect Ratio AR

The term “aspect ratio” refers a ratio of the length to the diameter of a fibrous conductive material 22c shown in FIG. 3B. Preferably, the conductive material 22c has an aspect ratio AR of thirty or greater to improve a conductive network of the positive electrode mixture layer 22. When the aspect ratio AR is thirty or greater, even a small mass of the conductive material 22c can form an effective conductive network. This allows the amount of the conductive material 22c added to the positive electrode mixture layer 22 to be decreased, thereby increasing porosity P (%). A typical conductive material 22c shown in FIG. 3A includes particles of, for example, carbon black, such as acetylene black (AB) or ketjen black, black lead (graphite), and the like. These particles are granular and have a small aspect ratio AR. Accordingly, the particles need to have a certain level of density in order to form a conductive network efficiently. Examples of the conductive material 22c that has a large aspect ratio AR and forms a conductive network efficiently include carbon nanotubes (CNT) and carbon nanofibers (CNF).

### Solid Content Ratio NV

The solid content ratio NV (non-volatile matter content) (%) refers to a ratio of a solid content to a liquid when preparing a mixture of the solid and the liquid. A concentration may be expressed using weight (wt %) or volume (vol %). Weight (wt %) is used to indicate the concentration of a mixture of a solid and a liquid. Either weight (wt %) or volume (vol %) is used to indicate the concentration of a mixture of liquids. In the present embodiment, the solid content ratio NV (%) refers to a ratio of the mass (g) of a positive electrode mixture paste subsequent to a drying step to the mass (g) of the positive electrode mixture paste subsequent to an application step. Specifically, the solid content ratio NV (%) is measured by a method specified in “JIS K 5601_1_2, Testing methods for paint components, Part 1, Section 2: Heating residue”.

In other words, when the solid content ratio NV (%) is low, a solvent has a high mass ratio and thus a positive electrode mixture paste 22a is highly fluid. Thus, the particles of the positive electrode active material 22b will precipitate after an application step (S2, S4) due to gravity, and the conductive material 22c having a small specific weight will float.

### Principles of Present Embodiment

### Surface Area S and Specific Surface Area B

As described in Background section, the amount of reaction occurring in the positive electrode plate 2 of the electrode body 12 depends on the surface area S_{A} (m²) of the positive electrode active material 22b that produces the main reaction of the battery. Thus, it is desirable that the particles of the positive electrode active material 22b have a large surface area S_{A} (m²). Further, even with the same amount of the positive electrode active material 22b, if the positive electrode active material 22b has a relatively large specific surface area (BET) (m²/g), the reactive area of the positive electrode active material 22b increases. Thus, it is desirable that the particles of the positive electrode active material 22b also have a large specific surface area (BET) (m²/g).

On the other hand, the conductive material 22c is necessary to increase the conductivity of the positive electrode mixture layer 22. Thus, it is desirable to mix a sufficient amount of the conductive material 22c with the positive electrode active material 22b. However, since the conductive material 22c does not produce the main reaction of the battery, if the added amount of the conductive material 22c is too large, the percentage of the positive electrode active material 22b decreases. Consequently, the battery performance qualities would be reduced. Further, even with the same amount of the conductive material 22c, if the conductive material 22c has a relatively large specific surface area (BET) (m²/g), a conductive network is formed relatively easily. Thus, it is desirable that the conductive material 22c also has a large specific surface area (BET) (m²/g).

Therefore, the balance between the surface areas S (m²) taking into consideration the specific surface areas (BET) (m²/g) is an important element in determining appropriate percentages of the positive electrode active material 22b and the conductive material 22c.

### Aspect Ratio AR and Porosity P

FIGS. 3A to 3C show relationships between the particles of the positive electrode active material 22b, the conductive material 22c, a binder 22d, and the non-aqueous electrolyte 13. FIG. 3A shows the relationship between the particles of the positive electrode active material 22b, the conductive material 22c, and the non-aqueous electrolyte 13 when the porosity P is high and the conductive material 22c has a low aspect ratio AR.

In the present example, the conductive material 22c includes particles of carbon black, such as acetylene black (AB) or ketjen black, black lead (graphite), and the like. The particles of the conductive material 22c are granular and have a small aspect ratio (ratio of length to diameter). The conductive material 22c having such a small aspect ratio AR reduces contact between the particles. Thus, unless the conductive material 22c has a certain level of density, the conductive material 22c fails to form an effective conductive network between the non-aqueous electrolyte 13 and the positive electrode active material 22b.

FIG. 3B shows the relationship between the particles of the positive electrode active material 22b, a fibrous conductive material 22c, and the non-aqueous electrolyte 13 when the porosity P is high and the conductive material 22c has a large aspect ratio AR. For example, the conductive material 22c having an aspect ratio AR of thirty or greater, such as carbon nanotubes (CNT) and carbon nanofibers (CNF), is in the form of strings. Thus, as shown in FIG. 3B, the strings of the conductive material 22c having a large aspect ratio AR readily contact one another and form an effective conductive network even if the amount of the conductive material 22c is small. Accordingly, even if the amount of the conductive material 22c is decreased, the large aspect ratio AR forms a conductive network that is equivalent to that of a conductive material 22c having a small aspect ratio AR. In other words, the reduction in the amount of the conductive material 22c allows for an increase in the amount of the positive electrode active material 22b.

FIG. 3C shows the relationship between the particles of the positive electrode active material 22b having a low porosity P, the conductive material 22c, and the non-aqueous electrolyte 13. For example, when a large amount of the particles of the positive electrode active material 22b and a large amount of the conductive material 22c are mixed in the positive electrode mixture layer 22 to increase the surface area S (m²), the average value of the gap G between the particles of the conductive material 22c decreases. In this case, although the surface area S_{A} (m²) of the particles of the positive electrode active material 22b and the surface area S_{C} (m²) of the conductive material 22c are increased, the porosity P (%) of the positive electrode mixture layer 22 decreases. This hinders the entry of the non-aqueous electrolyte 13 into the positive electrode mixture layer 22. As a result, diffusion of Li-ions in the positive electrode active material 22b is impaired and the main reaction of the battery would be adversely affected. Therefore, it is necessary to obtain an appropriate porosity P (%) so as to ensure the flow of the non-aqueous electrolyte 13, which is required by the main reaction of the battery.

### Features of Present Embodiment

Comprehensive considerations of the above principles have concluded that in order to achieve higher battery performance qualities, it is necessary to optimize the percentages of the conductive material 22c and the positive electrode active material 22b by examining multiple factors, such as the percentage R_{C} (mass %) of the conductive material 22c in the positive electrode mixture, the specific surface area B_{C} (m²/g) of the conductive material 22c, the surface area S_{C} (m²) of the conductive material 22c, the percentage R_{A} (mass %) of the positive electrode active material 22b in the positive electrode mixture, the specific surface area B_{A} (m²/g) of the positive electrode active material 22b, and the surface area S_{A} (m²) of the positive electrode active material 22b. In other words, the percentage R_{C} (mass %) of the conductive material 22c in the positive electrode mixture refers to the percentage R_{C} (mass %) of the mass of the conductive material 22c in the positive electrode mixture relative to the total mass of the positive electrode mixture. Further, the percentage R_{A} (mass %) of the positive electrode active material 22b in the positive electrode mixture refers to the percentage R_{A} (mass %) of the mass of the positive electrode active material 22b in the positive electrode mixture to the total mass of the positive electrode mixture.

In order to comprehensively optimize the above values, the present embodiment introduces a concept of “total surface area ratio R_{S}” and obtains optimal values using an equation of R_{S}=(R_{C}×B_{C})/(R_{A}× B_{A}).

Further, the aspect ratio AR and the porosity P (%) are also considered to obtain a further desirable mixing ratio.

The present embodiment will now be described in detail.

### Configuration of Present Embodiment

First, the structure of the lithium-ion rechargeable battery 1 in accordance with the present embodiment will be described.

### Structure of Lithium-Ion Rechargeable Battery 1

FIG. 1 is a perspective view schematically showing the structure of the lithium-ion rechargeable battery 1 in accordance with the present embodiment. The structure of the lithium-ion rechargeable battery 1 of the present embodiment is as follows. As shown in FIG. 1, the lithium-ion rechargeable battery 1 is structured as a battery cell. The lithium-ion rechargeable battery 1 includes a main body of a box-shaped battery case 11 having an opening in the upper side. The battery case 11 accommodates an electrode body 12. The battery case 11 is filled with a non-aqueous electrolyte 13 injected through a liquid-injection hole arranged in a lid. The battery case 11 is formed from metal, such as an aluminum alloy, and forms a sealed battery container when the main body and the lid are closed by laser welding or the like. Further, the lithium-ion rechargeable battery 1 includes a positive electrode external terminal 14 and a negative electrode external terminal 15 used for charging and discharging of the lithium-ion rechargeable battery 1. The shapes of the positive electrode external terminal 14 and the negative electrode external terminal 15 are not limited to those shown in FIG. 1.

### Electrode Body 12

FIG. 2 is a diagram schematically showing the structure of a partially unrolled electrode body 12. The electrode body 12 is formed by a flat roll of positive electrode plates 2, negative electrode plates 3, and separators 4 held in between the positive electrode plates 2 and the negative electrode plates 3.

In each positive electrode plate 2, a positive electrode mixture layer 22 is formed on a positive electrode current collector 21 that serves as a substrate. As shown in FIG. 2, the positive electrode plate 2 includes a positive electrode connection portion 23 at one end of the electrode body 12 (opposite to negative electrode connection portion 33, upper side in FIG. 2) in a widthwise direction W (rolling-axis direction) that is orthogonal to the direction in which the positive electrode current collector 21 is rolled (rolling direction L). The positive electrode connection portion 23 is where the positive electrode mixture layer 22 is not formed and the metal of the positive electrode current collector 21 is exposed.

In each negative electrode plate 3, a negative electrode mixture layer 32 is formed on a negative electrode current collector 31 that serves as a substrate. The negative electrode plate 3 includes a negative electrode connection portion 33 at the other one end of the electrode body 12 (lower side in FIG. 2) in the widthwise direction W (rolling-axis direction) that is orthogonal to the direction in which the negative electrode current collector 31 is rolled (rolling direction L). The negative electrode connection portion 33 is where the negative electrode mixture layer 32 is not formed and the negative electrode current collector 31 is exposed.

### Components of Electrode Body 12

The components of the electrode body 12, namely, the positive electrode plate 2, the negative electrode plate 3, and the separator 4, will now be described.

### Positive Electrode Plate 2

The positive electrode plate 2 includes the positive electrode current collector 21 and the positive electrode mixture layer 22 applied to the positive electrode current collector 21.

### Positive Electrode Current Collector 21

The positive electrode plate 2 has a structure in which the positive electrode mixture layer 22 is formed on both surfaces of the positive electrode current collector 21, which serves as the positive electrode substrate. The positive electrode current collector 21 is formed by an Al foil in the embodiment. The positive electrode current collector 21 acts as the body and the base of the positive electrode mixture layer 22. Further, the positive electrode current collector 21 functions as a current collecting member that collects electricity from the positive electrode mixture layer 22.

An Al foil is described above as an example of the positive electrode substrate that forms the positive electrode current collector 21. The positive electrode substrate is formed from, for example, a conductive material including a satisfactory conductive metal. The conductive material may include, for example, a material including aluminum or an aluminum alloy. However, the structure of the positive electrode current collector 21 is not limited as such.

### Positive Electrode Mixture Layer 22

The positive electrode mixture layer 22 is formed by applying a positive electrode mixture paste 22a to the positive electrode current collector 21 and drying the paste. The positive electrode mixture layer 22 includes additives such as a conductive material 22c, a binder 22d, a dispersant, and the like, in addition to positive electrode active material 22b.

Percentages of Positive Electrode Active Material 22b and Conductive Material 22c in Positive Electrode Mixture Layer 22

The percentage of the conductive material 22c in the positive electrode mixture is represented by R_{C} (mass %). The specific surface area (m²/g) of the conductive material 22c is represented by B_{C} (m²/g). The percentage of the positive electrode active material 22b in the positive electrode mixture is represented by R_{A} (mass %). The specific surface area (m²/g) of the positive electrode active material 22b is represented by B_{A} (m²/g). The total surface area ratio is represented by R_{S}. Further, R_{S}=(R_{C}×B_{C})/(R_{A}× B_{A}) is satisfied. In this case, the total surface area ratio R_{S} is set in a range of 0.20 to 1.93.

In this case, the aspect ratio AR of the conductive material 22c is thirty or greater.

Further, the porosity P is set in a range of 40% to 55%.

Preferably, the total surface area ratio R_{S} is in a range of 0.92 to 1.93, and the specific surface area B_{A} (m²/g) of the positive electrode active material is set in a range of 1.6 to 2.0 (m²/g). Also, the specific surface area B_{C} (m²/g) of the conductive material 22c is set in a range of 180 to 200 (m²/g), and the percentage R_{C} of the conductive material 22c in the positive electrode mixture is set in a range of 1.0 to 1.5 (mass %).

### Density Difference Within Positive Electrode Mixture Layer 22

The positive electrode mixture layer 22 of the positive electrode plate 2 is divided into two regions, namely, an upper side (toward separator 4) and a lower side (toward positive electrode current collector 21). Specifically, the positive electrode mixture layer 22 of the positive electrode plate 2 is divided in a thickness-wise direction of the positive electrode mixture layer 22 into two regions, a separator region 22f located closer to the separator 4, and a positive electrode current collector region 22g located closer to the positive electrode current collector 21. In this case, the mass M_{UP} (g) of the conductive material 22c present in the separator region 22f of the positive electrode mixture layer 22 is set to be greater than the mass M_{LOW} (g) of the conductive material 22c present in the positive electrode current collector region 22g.

Further, the porosity P_{LOW} (%) of the positive electrode current collector region 22g of the positive electrode mixture layer 22 is set to be greater than the porosity P_{UP} (%) of the separator region 22f of the positive electrode mixture layer 22.

More specifically, a conductive material upper-lower ratio R_{M} is set in a range of 1.5 to 17.75, where the conductive material upper-lower ratio R_{M} is a mass ratio of the mass M_{UP} (g) of the conductive material 22c present in the separator region 22f of the positive electrode mixture layer 22 to the mass M_{LOW} (g) of the conductive material 22c present in the positive electrode current collector region 22g of the positive electrode mixture layer 22.

Furthermore, a porosity upper-lower ratio R_{P} is set in a range of 1.1 to 1.70, where the porosity upper-lower ratio R_{P} is a ratio of the porosity P_{LOW} (%) of the positive electrode current collector region 22g of the positive electrode mixture layer 22 to the porosity P_{UP} (%) of the separator region 22f of the positive electrode mixture layer 22.

### Positive Electrode Mixture Paste 22a

The positive electrode mixture paste 22a is a paste obtained by adding a solvent 22e to the additives such as the conductive material 22c, the binder 22d, the dispersant, and the like, in addition to the positive electrode active material 22b. The solvent 22e is a non-aqueous organic solvent that adjusts the viscosity of the positive electrode mixture paste 22a. The viscosity is adjusted in accordance with a prespecified solid content ratio NV.

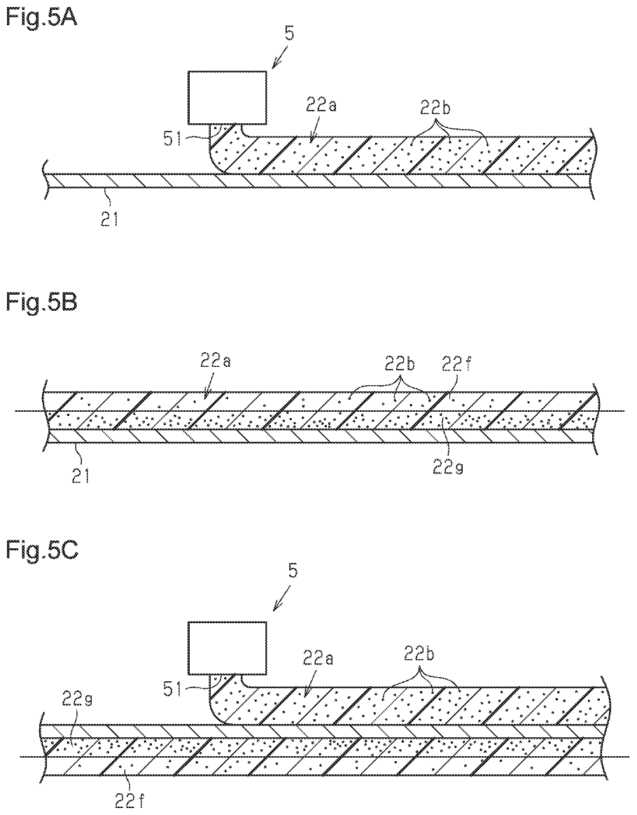

FIGS. 5A to 5C are diagrams schematically showing steps of a positive electrode plate manufacturing process. FIG. 5A is a diagram schematically showing a step of applying the positive electrode mixture paste 22a on the front surface of the positive electrode current collector 21, or a front-surface positive electrode mixture paste application step (S2). FIG. 5B is a diagram schematically showing a first drying step (S3). FIG. 5C is a diagram schematically showing a step of applying the positive electrode mixture paste 22a on the back-surface of the positive electrode current collector 21, or a back-surface positive electrode mixture paste application step (S4).

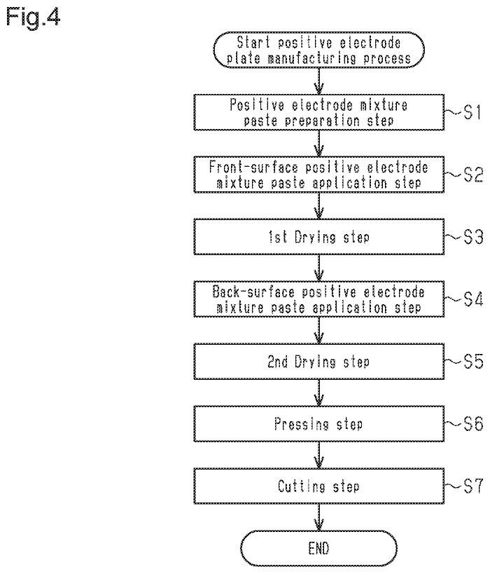

In the positive electrode mixture layer 22, the positive electrode mixture paste 22a is applied to the positive electrode current collector 21 in the application steps (front-surface positive electrode mixture paste application step S2 shown in FIG. 5A, and back-surface positive electrode mixture paste application step S4 shown in FIG. 5C) shown in FIG. 4. Then, the positive electrode mixture paste 22a is dried and fixed to the positive electrode mixture layer 22 in the drying steps (first drying step S3 shown in FIG. 5B, and second drying step S5, not shown). At the stage shown in FIG. 5A, the solvent 22e is mixed with the positive electrode mixture paste 22a. However, after the first drying step (S3) shown in FIG. 5B, the volatilized solvent 22e is absent from the positive electrode mixture layer 22.

### Composition of Positive Electrode Active Material 22b

The primary particles of the positive electrode active material 22b include a lithium transition metal oxide having a layered crystalline structure. The lithium transition metal oxide includes one or more predetermined transition metal elements in addition to Li. Preferably, the transition metal element included in the lithium transition metal oxide is at least one of Ni, Co, and Mn. Preferably, the lithium transition metal oxide includes every one of Ni, Co, and Mn.

The positive electrode active material 22b may include one or more types of elements in addition to the transition metal element (i.e., at least one of Ni, Co, and Mn). The additional element may include any element in group 1 (alkali metal such as sodium), group 2 (alkaline earth metal such as magnesium or calcium), group 4 (transition metal such as titanium or zirconium), group 6 (transition metal such as chromium or tungsten), group 8 (transition metal such as iron), group 13 (metalloid element such as boron or metal such as aluminum) or group 17 (halogen such as fluorine) of the periodic table.

In a preferred embodiment, the positive electrode active material 22b may have a composition (average composition) represented by the following general expression (1).

Li₁+xNi_{y}CO_{z}Mn_{(1-y-z)}MA_{α}MB_{β}O₂ (1)

In expression 1, the “x” may be a real number that satisfies 0≤ x≤0.2. The “y” may be a real number that satisfies 0.1<y<0.6. The “z” may be a real number that satisfies 0.1<z<0.6. The “MA” is at least one type of metal element selected from W, Cr, and Mo. The “a” is a real number that satisfies 0<α≤0.01 (typically, 0.0005≤α≥0.01, for example, 0.001≤ α≤ 0.01). The “MB” may be one or more types of elements selected from the group consisting of Zr, Mg, Ca, Na, Fe, Zn, Si, Sn, Al, B, and F. The “B” may be a real number that satisfies 0≤β≤ 0.01. The “B” may be substantially zero (that is, oxide including substantially no MB). To facilitate understanding, the chemical formula that expresses the lithium transition metal oxide having a layered structure indicates two as the composition ratio of O (oxygen). However, this numerical value should not be strictly interpreted, and some variations of the composition (typically included in range of 1.95 to 2.05) are allowable.

### Conductive Material 22c

The conductive material 22c is a material that forms conductive paths in the positive electrode mixture layer 22. When an appropriate amount of the conductive material is mixed in the positive electrode mixture layer 22, the conductivity of the positive electrode is increased. This enhances the charging/discharging efficiency and the output characteristic of the battery. The conductive material 22c of the present embodiment is in the form of strings having the aspect ratio AR of thirty or greater, as described above. The conductive material 22c of the present embodiment may include, for example, a carbon material such as carbon nanotubes (CNT), carbon nanofibers (CNF), or the like.

### Binder 22d

The binder 22d may include, for example, polyvinylidene fluoride (PVDF), polytetrafluoroethylene (PTFE), polyacrylic acid, polyacrylate, or the like.

### Negative Electrode Plate 3

The negative electrode plate 3 has a structure in which the negative electrode mixture layer 32 is formed on both surfaces of the negative electrode current collector 31, which serves as the negative electrode substrate. The negative electrode current collector 31 is formed by a Cu foil in the embodiment. The negative electrode current collector 31 acts as the body and the base of the negative electrode mixture layer 32. Further, the negative electrode current collector 31 functions as a current collecting member that collects electricity from the negative electrode mixture layer 32. In the present embodiment, a negative electrode active material includes a material that is capable of storing and releasing lithium ions, namely, powders of a carbon material such as graphite or the like.

The negative electrode plate 3 is prepared by, for example, kneading the negative electrode active material, a solvent, and a binder, applying the kneaded negative electrode mixture paste to the negative electrode current collector 31, and then drying the paste.

### Separator 4

The separator 4 may include a porous sheet formed from resin, such as polyethylene (PE), polypropylene (PP), or the like, so as to hold the non-aqueous electrolyte 13 between the positive electrode plate 2 and the negative electrode plate 3. Such a porous resin sheet may have a single-layer structure in which only one type of material is used. Alternatively, the porous resin sheet may have a multilayer structure in which various types of materials are combined.

### Non-Aqueous Electrolyte 13

As shown in FIG. 1, the battery container formed by the battery case 11 is filled with the non-aqueous electrolyte 13. The non-aqueous electrolyte 13 of the lithium-ion rechargeable battery 1 is a composition in which a lithium salt is dissolved in an organic solvent. The lithium salt may include LiClO₄, LiPF₆, LiAsF₆, LiBF₄, LiSO₃CF₃, or the like. Examples of the organic solvent include a cyclic carbonate such as ethylene carbonate, propylene carbonate, butylene carbonate, and trifluoropropylene carbonate; a chain carbonate such as diethyl carbonate, dimethyl carbonate, ethyl methyl carbonate, and dipropyl carbonate: an ether compound such as tetrahydrofuran, 2-methyltetrahydrofuran, and dimethoxyethane: a sulfur compound such as ethyl methyl sulfone and butane sultone; and a phosphorus compound such as triethyl phosphate and trioctyl phosphate. The non-aqueous electrolyte may include one selected from the above or a mixture of two or more selected from the above. The composition of the non-aqueous electrolyte 13 is not limited as such.

### Method for Manufacturing Positive Electrode Plate 2

FIG. 4 is a flowchart illustrating the steps of the positive electrode plate manufacturing process. The positive electrode plate 2 of the lithium-ion rechargeable battery 1 of the present embodiment is manufactured in the following steps. Each step will now be described with reference to the flowchart shown in FIG. 4.

### Positive Electrode Mixture Paste Preparation Step (S1)

In a positive electrode mixture paste preparation step (S1), the positive electrode mixture paste 22a having the above-described composition is manufactured. In this case, the viscosity of the positive electrode mixture paste 22a is adjusted by determining the amount of the solvent 22e based on the solid content ratio NV that is set in accordance with a predetermined viscosity (Pa-s).

### Front-Surface Positive Electrode Mixture Paste Application Step (S2)

As shown in FIG. 5A, in a front-surface positive electrode mixture paste application step (S2), an uncut strip of the positive electrode current collector 21 is conveyed by a constant-speed transporter, such as a belt conveyor, from a feed reel (not shown) on which the positive electrode current collector 21 is wound. A coating machine 5 is arranged above the positive electrode current collector 21, which is conveyed at a constant speed. The positive electrode mixture paste 22a that is sufficiently stirred and homogenized is supplied to the coating machine 5 from a storage tank (not shown) in which the positive electrode mixture paste 22a is stored. The coating machine 5 discharges a constant amount of the positive electrode mixture paste 22a from a nozzle 51 at a constant pressure. A constant gap is formed between the nozzle 51 and the positive electrode current collector 21, and the positive electrode mixture paste 22a discharged from the nozzle 51 flows downward due to gravity and forms a constant thickness on the surface (upper surface in FIG. 5A) of the positive electrode current collector 21.

The positive electrode mixture paste 22a, which has just been applied in the front-surface positive electrode mixture paste application step (S2), has a viscosity that is adjusted in accordance with the solid content ratio NV.

### First Drying Step (S3)

In a first drying step (S3), the positive electrode mixture paste 22a applied in the front-surface positive electrode mixture paste application step (S2) is heated to volatilize the solvent 22e. This dries and hardens the positive electrode mixture paste 22a.

In the first drying step (S3), the temperature of the positive electrode mixture layer 22 gradually increases and causes an effect of “migration”. Migration is an effect in which metallic components influenced by an electric field move on or inside a non-metallic medium across the non-metallic medium. Typically, electromigration caused by a current flow will be outstanding. However, even when there is no current, ionic migration may occur due to electrolysis.

In the first drying step (S3) of this embodiment, as shown in FIG. 5B, the positive electrode active material 22b having a relatively high density is attracted by the positive electrode current collector 21 and moved downward. The positive electrode active material 22b is also affected by gravitational acceleration. The conductive material 22c and the binder 22d (not shown) having a relatively low density move upward in FIG. 5B away from the positive electrode current collector 21. The binder 22d moves upward in FIG. 5B away from the positive electrode current collector 21. This lowers the porosity P_{LOW} (%) of the positive electrode active material 22b that is attracted by the positive electrode current collector 21.

Such a movement of migration depends on the viscosity (Pa-s) and the time (s). Thus, the viscosity (Pa-s) of the positive electrode mixture paste 22a is set in accordance with the solid content ratio NV to obtain an intended balance. Further, the drying temperature (° C.) and the drying time period (s) are set to control the movement period. As a result, the positive electrode active material 22b, the conductive material 22c, the binder, and the like move by desirable amounts.

Specifically, the positive electrode mixture layer 22 is set such that the conductive material upper-lower ratio R_{M} after the first drying step (S3) is set in a range of 1.5 to 20. The conductive material upper-lower ratio R_{M} is a ratio of the mass M_{UP} (g) of the conductive material 22c present in the separator region 22f of the positive electrode mixture layer 22 to the mass M_{LOW} (g) of the conductive material 22c present in the positive electrode current collector region 22g of the positive electrode mixture layer 22.

Further, the porosity upper-lower ratio R_{P} is set in a range of 1.1 to 12. The porosity upper-lower ratio R_{P} is a ratio of the porosity P_{LOW} (%) of the positive electrode current collector region 22g of the positive electrode mixture layer 22 to the porosity P_{UP} (%) of the separator region 22f of the positive electrode mixture layer 22.

### Back-Surface Positive Electrode Mixture Paste Application Step (S4)

As shown in FIG. 5C, when the first drying step (S3) is completed and the positive electrode mixture layer 22 is hardened, the positive electrode current collector 21 is turned upside down and a back-surface positive electrode mixture paste application step (S4) is performed on the back surface of the positive electrode current collector 21.

The procedure in this step is the same as that of the front-surface positive electrode mixture paste application step (S2).

The present example is not intended to exclude an embodiment in which the positive electrode mixture layer 22 is formed only on one surface of the positive electrode current collector 21 or an embodiment in which the positive electrode mixture layer 22 differs in thickness between the two surfaces.

### Second Drying Step (S5)

A second drying step (S5) is the same step as the first drying step (S3).

### Pressing Step (S6)

In a pressing step (S6) that follows the second drying step (S5), a roller pressing machine (not shown) presses the positive electrode plate 2 on which the positive electrode mixture layer 22 is formed. The roller pressing machine maintains a predetermined distance from the positive electrode plate 2 so that the pressed positive electrode plate 2 becomes flat and has the set thickness.

### Cutting Step (S7)

The positive electrode plate 2 shaped in the pressing step (S6) is cut to a desired length.

### Post-Process

As shown in FIG. 2, the manufactured positive electrode plate 2 is rolled together with the negative electrode plate 3 and the separator 4, which insulates the positive electrode plate 2 and the negative electrode plate 3, to form the electrode body 12. The positive electrode external terminal 14 is connected to the positive electrode connection portion 23 of the electrode body 12 via the lid of the battery case 11. The negative electrode external terminal 15 is connected to the negative electrode connection portion 33 of the electrode body 12 via the lid of the battery case 11. The electrode body 12 is accommodated in the main body of the battery case 11. The lid and the main body of the battery case 11 are sealed by laser welding or the like. Then, the inside of the battery case 11 is dried in a drying step. When the inside of the battery case 11 is dried, the battery case 11 is filled with the non-aqueous electrolyte 13 in a liquid injection step. Subsequently, an solid electrolyte interphase (SEI) film is formed through initial charging in a conditioning step. After micro-short-circuits are eliminated in an aging step, various inspections are performed. Specifically, open circuit voltage OCV, battery capacity, internal resistance, and the like are inspected. When there is no abnormality, the battery is shipped as a product.

### Operation of Present Embodiment

The operation of the lithium-ion rechargeable battery 1 and the method for manufacturing the positive electrode plate 2 of the lithium-ion rechargeable battery 1 according to the present embodiment will now be described.

The conductive material 22c such as fibrous CNT having an aspect ratio AR of thirty or greater efficiently forms a conductive network. Thus, the amount of the conductive material 22c can be reduced.

Further, a smaller amount of the conductive material 22c increases the porosity P (%), thereby reducing the Li ion diffusion resistance.

The necessary amount of the conductive material 22c having an aspect ratio AR of thirty or greater is determined in accordance with the specific surface area B_{A} of the positive electrode active material 22b and the specific surface area B_{C} of the conductive material 22c. The amount of the conductive material 22c is minimized when the total surface area ratio R_{S} is set in a specified range.

When the positive electrode active material 22b has a large specific surface area B_{A}, the amount of the conductive material 22c is increased in order to form necessary conductive paths.

On the other hand, when the conductive material 22c has a large specific surface area B_{C}, the amount of the conductive material 22c is reduced because even a small amount of the conductive material 22c readily forms the conductive paths.

When the porosity is too high, the contact between the particles of the conductive material 22c is reduced and thus conductive paths are not formed. On the other hand, when the porosity P is too low, although the conductive paths are formed, the reduced volume of voids hinders the non-aqueous electrolyte 13 from entering into the positive electrode active material 22b of the positive electrode plate 2. This increases the liquid diffusion resistance and impedes diffusion of Li ions. Accordingly, the porosity P is set within a specified range to avoid the above problems.

### Experimental Example 1

The lithium-ion rechargeable battery 1 and the method for manufacturing the positive electrode plate 2 of the lithium-ion rechargeable battery 1 in accordance with the present embodiment have the above-described configuration and operation. Examples and Comparative Examples of the lithium-ion rechargeable battery 1 in accordance with the present embodiment will now be described.

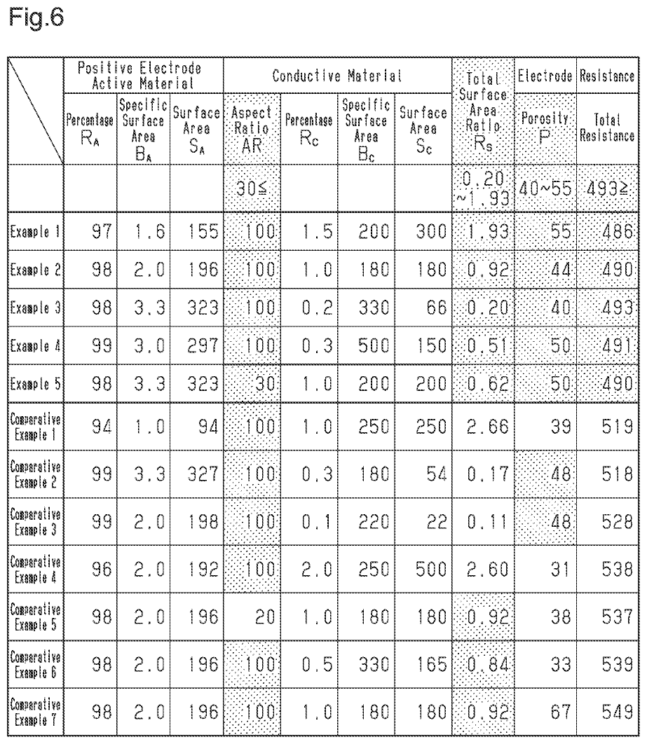

FIG. 6 is a table showing the results of Experiment 1. The rows of the table indicate reference values, the results of Examples 1 to 5, and the results of Comparative Examples 1 to 7. The columns of the table indicate, from the left side, the percentage R_{A} (mass %) of the positive electrode active material 22b in the positive electrode mixture, the specific surface area B_{A} (BET value) (m²/g) of the positive electrode active material 22b, and the surface area S_{A} (m²) of the positive electrode active material 22b. Then, the aspect ratio AR of the conductive material 22c, the percentage R_{C} (mass %) of the conductive material 22c in the positive electrode mixture, the specific surface area (BET value) B_{C} (m²/g) of the conductive material 22c, and the surface area S_{C} (m²) of the conductive material 22c are indicated. Further, the total surface area ratio R_{S}, which is obtained from the equation of R_{S}=(R_{C}×B_{C})/(R_{A}×B_{A}), the porosity P (%) of the positive electrode mixture layer 22, and then the internal resistance DC-IR (mΩ) of the lithium-ion rechargeable battery 1 are indicated.

### Reference Value

The reference values represent the preferred ranges of the present invention. In Examples of the present embodiment, the aspect ratio AR, the total surface area ratio R_{S}, the porosity P of the positive electrode mixture layer 22, and the internal resistance DC-IR are all within the reference value ranges. Further, in each Comparative Example of the present embodiment, at least one of these characteristics is out of the reference value ranges. The reference value ranges do not limit the present invention.

A reference value of the aspect ratio AR is thirty or greater. A reference value of the total surface area ratio R_{S} is in a range of 0.2 to 1.93. A reference value of the porosity P (%) of the positive electrode mixture layer 22 is in a range of 40% to 55%. A reference value of the internal resistance DC-IR (mΩ) is less than or equal to 493 mΩ.

### Example 1

In Example 1, in relation to the positive electrode active material 22b, the percentage R_{A} (mass %) was 97 mass %, the specific surface area B_{A} (BET value) (m²/g) was 1.6 m²/g, and the surface area S_{A} (m²) was 155 m². In relation to the conductive material 22c, the aspect ratio AR was 100, the percentage R_{C} (mass %) was 1.5 mass %, the specific surface area (BET value) B_{C} (m²/g) was 200 m²/g, and the surface area S_{C} (m²) was 300 m². The total surface area ratio R_{S} was 1.93. The porosity P (%) of the positive electrode mixture layer 22 was 55%. The internal resistance DC-IR (mΩ) was 486 mΩ.

The aspect ratio AR, the total surface area ratio R_{S}, and the porosity P all satisfied the conditions of the reference values.

### Example 2

In Example 2, in relation to the positive electrode active material 22b, the percentage R_{A} (mass %) was 98 mass %, the specific surface area B_{A} (BET value) (m²/g) was 2.0 m²/g, and the surface area S_{A} (m²) was 196 m². In relation to the conductive material 22c, the aspect ratio AR was 100, the percentage R_{C} (mass %) was 1.0 mass %, the specific surface area (BET value) B_{C} (m²/g) was 180 m²/g, and the surface area S_{C} (m²) was 180 m². The total surface area ratio R_{S} was 0.92. The porosity P (%) of the positive electrode mixture layer 22 was 44%. The internal resistance DC-IR (mΩ) was 490 mΩ.

The aspect ratio AR, the total surface area ratio R_{S}, and the porosity P all satisfied the conditions of the reference values.

### Example 3

In Example 3, in relation to the positive electrode active material 22b, the percentage R_{A} (mass %) was 98 mass %, the specific surface area B_{A} (BET value) (m²/g) was 3.3 m²/g, and the surface area S_{A} (m²) was 323 m². In relation to the conductive material 22c, the aspect ratio AR was 100, the percentage R_{C} (mass %) was 0.2 mass %, the specific surface area (BET value) B_{C} (m²/g) was 330 m²/g, and the surface area S_{C} (m²) was 66 m². The total surface area ratio R_{S} was 0.20. The porosity P (%) of the positive electrode mixture layer 22 was 40%. The internal resistance DC-IR (mΩ) was 493 mΩ.

The aspect ratio AR, the total surface area ratio R_{S}, and the porosity P all satisfied the conditions of the reference values.

### Example 4

In Example 4, in relation to the positive electrode active material 22b, the percentage R_{A} (mass %) was 99 mass %, the specific surface area B_{A} (BET value) (m²/g) was 3.0 m²/g, and the surface area S_{A} (m²) was 297 m². In relation to the conductive material 22c, the aspect ratio AR was 100, the percentage R_{C} (mass %) was 0.3 mass %, the specific surface area (BET value) B_{C} (m²/g) was 500 m²/g, and the surface area S_{C} (m²) was 150 m². The total surface area ratio R_{S} was 0.51. The porosity P (%) of the positive electrode mixture layer 22 was 50%. The internal resistance DC-IR (mΩ) was 491 mΩ.

The aspect ratio AR, the total surface area ratio R_{S}, and the porosity P all satisfied the conditions of the reference values.

### Example 5

In Example 5, in relation to the positive electrode active material 22b, the percentage R_{A} (mass %) was 98 mass %, the specific surface area B_{A} (BET value) (m²/g) was 3.3 m²/g, and the surface area S_{A} (m²) was 323 m². In relation to the conductive material 22c, the aspect ratio AR was 30, the percentage R_{C} (mass %) was 1.0 mass %, the specific surface area (BET value) B_{C} (m²/g) was 200 m²/g, and the surface area S_{C} (m²) was 200 m². The total surface area ratio R_{S} was 0.62. The porosity P (%) of the positive electrode mixture layer 22 was 50%. The internal resistance DC-IR (mΩ) was 490 mΩ.

The aspect ratio AR, the total surface area ratio R_{S}, and the porosity P all satisfied the conditions of the reference values.

### Comparative Example 1

In Comparative Example 1, in relation to the positive electrode active material 22b, the percentage R_{A} (mass %) was 94 mass %, the specific surface area B_{A} (BET value) (m²/g) was 1.0 m²/g, and the surface area S_{A} (m²) was 94 m². In relation to the conductive material 22c, the aspect ratio AR was 100, the percentage R_{C} (mass %) was 1.0 mass %, the specific surface area (BET value) B_{C} (m²/g) was 250 m²/g, and the surface area S_{C} (m²) was 250 m². The total surface area ratio R_{S} was 2.66. The porosity P (%) of the positive electrode mixture layer 22 was 39%. The internal resistance DC-IR (mΩ) was 519 mΩ.

The condition of the aspect ratio AR was satisfied. The total surface area ratio R_{S} was too large, and the porosity P was too small, both not satisfying conditions of the reference values.

The internal resistance DC-IR (mΩ) increased because the surface area of the positive electrode active material 22b was small and the total surface area ratio R_{S} was high. Since the amount of the conductive material was too large and the porosity P was too small, the diffusion of the non-aqueous electrolyte 13 was insufficient.

### Comparative Example 2

In Comparative Example 2, in relation to the positive electrode active material 22b, the percentage R_{A} (mass %) was 99 mass %, the specific surface area B_{A} (BET value) (m²/g) was 3.3 m²/g, and the surface area S_{A} (m²) was 327 m². In relation to the conductive material 22c, the aspect ratio AR was 100, the percentage R_{C} (mass %) was 0.3 mass %, the specific surface area (BET value) B_{C} (m²/g) was 180 m²/g, and the surface area S_{C} (m²) was 54 m². The total surface area ratio R_{S} was 0.17. The porosity P (%) of the positive electrode mixture layer 22 was 48%. The internal resistance DC-IR (mΩ) was 518 mΩ.

The conditions of the aspect ratio AR and the porosity P were satisfied. The total surface area ratio R_{S} was too small and did not satisfy the condition of the reference value.

The internal resistance DC-IR (mΩ) increased because the surface area S_{A} of the positive electrode active material 22b was large and the total surface area ratio R_{S} was low. Since the amount of the conductive material 22c was not high enough, the conductive paths were not sufficiently formed.

### Comparative Example 3

In Comparative Example 3, in relation to the positive electrode active material 22b, the percentage R_{A} (mass %) was 99 mass %, the specific surface area B_{A} (BET value) (m²/g) was 2.0 m²/g, and the surface area S_{A} (m²) was 198 m². In relation to the conductive material 22c, the aspect ratio AR was 100, the percentage R_{C} (mass %) was 0.1 mass %, the specific surface area (BET value) B_{C} (m²/g) was 220 m²/g, and the surface area S_{C} (m²) was 22 m². The total surface area ratio R_{S} was 0.11. The porosity P (%) of the positive electrode mixture layer 22 was 48%. The internal resistance DC-IR (mΩ) was 528 mΩ.

The conditions of the aspect ratio AR and the porosity P were satisfied. The total surface area ratio R_{S} was too small and did not satisfy the condition of the reference value.

The internal resistance DC-IR (mΩ) increased because the surface area S_{C} of the conductive material 22c was small and the total surface area ratio R_{S} was low. Since the amount of the conductive material 22c was not high enough, the conductive paths were not sufficiently formed.

### Comparative Example 4

In Comparative Example 4, in relation to the positive electrode active material 22b, the percentage R_{A} (mass %) was 96 mass %, the specific surface area B_{A} (BET value) (m²/g) was 2.0 m²/g, and the surface area S_{A} (m²) was 192 m². In relation to the conductive material 22c, the aspect ratio AR was 100, the percentage R_{C} (mass %) was 2.0 mass %, the specific surface area (BET value) B_{C} (m²/g) was 250 m²/g, and the surface area S_{C} (m²) was 500 m². The total surface area ratio R_{S} was 2.60. The porosity P (%) of the positive electrode mixture layer 22 was 31%. The internal resistance DC-IR (mΩ) was 538 mΩ.

The condition of the aspect ratio AR was satisfied. The total surface area ratio R_{S} was too large, and the porosity P was too small, both not satisfying the conditions of the reference values.

The internal resistance DC-IR (mΩ) increased because the surface area S_{C} of the conductive material 22c was large and the total surface area ratio R_{S} was high. Since the amount of the conductive material 22c was too large and the porosity P was too small, the diffusion of the non-aqueous electrolyte 13 was insufficient.

### Comparative Example 5

In Comparative Example 5, in relation to the positive electrode active material 22b, the percentage R_{A} (mass %) was 98 mass %, the specific surface area B_{A} (BET value) (m²/g) was 2.0 m²/g, and the surface area S_{A} (m²) was 196 m². In relation to the conductive material 22c, the aspect ratio AR was 20, the percentage R_{C} (mass %) was 1.0 mass %, the specific surface area (BET value) B_{C} (m²/g) was 180 m²/g, and the surface area S_{C} (m²) was 180 m². The total surface area ratio R_{S} was 0.92. The porosity P (%) of the positive electrode mixture layer 22 was 38%. The internal resistance DC-IR (mΩ) was 537 mΩ.

The aspect ratio AR was too small and did not satisfy the condition. Although the total surface area ratio R_{S} satisfied the condition of the reference value, the porosity P was too small and did not satisfy the condition of the reference value.

The internal resistance DC-IR (mΩ) increased because the aspect ratio AR was low and the amount of the conductive material 22c was too small. Thus, the conductive paths were not sufficiently formed even though the porosity P was small.

### Comparative Example 6

In Comparative Example 6, in relation to the positive electrode active material 22b, the percentage R_{A} (mass %) was 98 mass %, the specific surface area B_{A} (BET value) (m²/g) was 2.0 m²/g, and the surface area S_{A} (m²) was 196 m². In relation to the conductive material 22c, the aspect ratio AR was 100, the percentage R_{C} (mass %) was 0.5 mass %, the specific surface area (BET value) B_{C} (m²/g) was 330 m²/g, and the surface area S_{C} (m²) was 165 m². The total surface area ratio R_{S} was 0.84. The porosity P (%) of the positive electrode mixture layer 22 was 33%. The internal resistance DC-IR (mΩ) was 539 mΩ.

The aspect ratio AR satisfied the condition of the reference value. Although the total surface area ratio R_{S} satisfied the condition of the reference value, the porosity P was too small and did not satisfy the condition of the reference value.

The internal resistance DC-IR (mΩ) increased because the porosity P was too small and the gap G was too narrow. This caused insufficient diffusion of the non-aqueous electrolyte 13.

### Comparative Example 7

In Comparative Example 7, in relation to the positive electrode active material 22b, the percentage R_{A} (mass %) was 98 mass %, the specific surface area B_{A} (BET value) (m²/g) was 2.0 m²/g, and the surface area S_{A} (m²) was 196 m². In relation to the conductive material 22c, the aspect ratio AR was 100, the percentage R_{C} (mass %) was 1.0 mass %, the specific surface area (BET value) B_{C} (m²/g) was 180 m²/g, and the surface area S_{C} (m²) was 180 m². The total surface area ratio R_{S} was 0.92. The porosity P (%) of the positive electrode mixture layer 22 was 67%. The internal resistance DC-IR (mΩ) was 549 mΩ.

The aspect ratio AR satisfied the condition of the reference value. Although the total surface area ratio R_{S} satisfied the condition of the reference value, the porosity P was too large and did not satisfy the condition of the reference value.

The internal resistance DC-IR (mΩ) increased because the porosity P (%) was too large and the conductive paths were not sufficiently formed.

### Summary of Experiment 1

The results of the above experiments are now summarized. In Examples 1 to 5, the aspect ratio AR was in a range of 30 to 100, the total surface area ratio R_{S} was in a range of 0.20 to 1.93, and the porosity P (%) was in a range of 40 to 55. The internal resistance DC-IR (mΩ) of the lithium-ion rechargeable battery 1 was in a low resistance range of 486 to 493 mΩ.

In Examples 1 to 5, particularly, in Examples 1 and 2, the internal resistance DC-IR (mΩ) was in a low range of 486 to 490 mΩ. In these cases, the total surface area ratio R_{S} was in a range of 0.92 to 1.93. The specific surface area B_{A} (m²/g) of the positive electrode active material 22b was in a range of 1.6 to 2.0 m²/g. The specific surface area B_{C} (m²/g) of the conductive material 22c was in a range of 180 to 200 m²/g. The percentage R_{C} (mass %) of the conductive material 22c in the positive electrode mixture was in a range of 1.0 to 1.5 mass %.

In Example 3, the total surface area ratio R_{S} was relatively low at 0.20, and the internal resistance DC-IR (mΩ) was slightly high at 493 mΩ.

In Example 4, the specific surface area B_{C} (m²/g) of the conductive material 22c was relatively large at 500 m²/g. The internal resistance DC-IR (mΩ) was slightly high at 491 mΩ.

In Example 5, the internal resistance DC-IR (mΩ) was low at 490 mΩ.

### Aspect Ratio AR

In Comparative Examples 1 to 4, 6, and 7, the aspect ratio AR was 100 and satisfied the condition of the reference value.

On the other hand, in Comparative Example 5, the aspect ratio AR was twenty and less than the lower limit of the reference value, which is thirty. In this case, the porosity P (%) was 38% and thus the voids were relatively small, which is advantageous for forming the conductive paths. Further, the total surface area ratio R_{S} was 0.92 and satisfied the condition of the reference value. However, the internal resistance DC-IR (mΩ) was as large at 537 mΩ. This result indicates that when the aspect ratio AR is not included in the reference value range of thirty or greater, the contact between the particles of the conductive material 22c is reduced. Thus, the conductive paths were insufficient to form an effective conductive network.

### Total Surface Area Ratio R_{S}

In Comparative Examples 5 to 7, the total surface area ratio R_{S} was included in the reference value range of 0.20 to 1.93.

On the other hand, in Comparative Examples 1 to 4, the total surface area ratio R_{S} was not included in the reference value range. In particular, in Comparative Examples 2 and 3, the internal resistances DC-IR (mΩ) was large at 518 mΩ and 528 mΩ, respectively, even though the aspect ratio AR and the porosity P (%) were included in the reference value ranges. This indicates that the internal resistance DC-IR (mΩ) increased because the total surface area ratios R_{S} of Comparative Examples 2 and 3 were 0.17 and 0.11, which are lower than the reference value range. In Comparative Example 2, the specific surface area B_{A} (m²/g) of the positive electrode active material 22b was high and the surface area S_{A} (m²) was large. This means that the amount of the conductive material 22c was not high enough. In Comparative Example 3, the surface area S_{C} (m²) of the conductive material 22c was small. This means that the amount of the conductive material 22c was not high enough. In Comparative Examples 1 and 4, the total surface area ratio R_{S} was greater than the reference value range. This indicates that the diffusion of the non-aqueous electrolyte 13 in the positive electrode mixture layer 22 was insufficient because the amount of the conductive material 22c was too large and the porosity P (%) was too small.

### Porosity P (%)

In Comparative Examples 2 and 3, the porosity P (%) was included in the reference value range of 40 to 55. On the other hand, in Comparative Examples 1 and 4 to 6, the porosity (%) was below the lower limit value of the reference value, which is forty.

In particular, in Comparative Example 6, even though the aspect ratio AR and the total surface area ratio R_{S} were included in the reference value ranges, the porosity P (%) was lower than the lower limit of the reference value range and the internal resistance DC-IR (mΩ) was large at 539 mΩ. This indicates that the diffusion of the non-aqueous electrolyte 13 in the positive electrode mixture layer 22 was insufficient because the porosity P (%) was low.

In Comparative Example 7, even though the aspect ratio AR and the total surface area ratio R_{S} were included in the reference value ranges, the porosity P (%) was greater than the upper limit value of the reference value range and the internal resistance DC-IR (mΩ) was large at 549 mΩ. This indicates that even when a sufficient amount of the conductive material 22c having a high porosity P (%) and a high aspect ratio AR is present, the contact between the particles of the conductive materials 22c is reduced. Thus, the conductive paths were insufficient to form an effective conductive network.

### SUMMARY

The necessary and sufficient conditions for reducing the internal resistance DC-IR (mΩ) were obtained through the above experiments. Specifically, the aspect ratio AR is in a range of 30 to 100, the total surface area ratio R_{S} is in a range of 0.20 to 1.93, and the porosity P (%) is in a range of 40 to 55. As a result, the internal resistance DC-IR (mΩ) of the lithium-ion rechargeable battery 1 is limited to a low resistance range of 486 to 493 mΩ. Preferably, following conditions are set to limit the internal resistance DC-IR (mΩ) to a low range of 486 to 490 mΩ. The total surface area ratio R_{S} is in a range of 0.92 to 1.93, the specific surface area B_{A} (m²/g) of the positive electrode active material 22b is in a range of 1.6 to 2.0 m²/g, the specific surface area B_{C} (m²/g) of the conductive material 22c is in a range of 180 to 200 m²/g, and the percentage R_{C} (mass %) of the conductive material 22c in the positive electrode mixture is in a range of 1.0 to 1.5 mass %.

Experiment 2: Conductive Material Upper-Lower Ratio R_{M}, Porosity Upper-Lower Ratio R_{P}

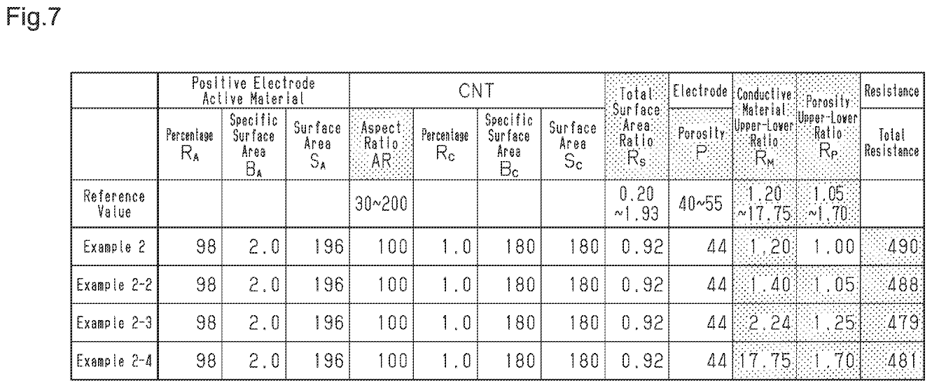

FIG. 7 is a table showing the results of Experiment 2. As described above, when migration occurs in the first drying step (S3) and the second drying step (S5), the particles move between the separator region 22f and the positive electrode current collector region 22g of the positive electrode mixture layer 22.

Further, the period of movement is controllable by setting the viscosity (Pa-s) of the positive electrode mixture paste 22a in accordance with the solid content ratio NV, the drying temperature (° C.), and the drying time period (s).

The positive electrode mixture layer 22 is configured such that the mass M_{UP} (g) of the conductive material 22c present in the separator region 22f of the positive electrode mixture layer 22 is greater than the mass M_{LOW} (g) of the conductive material 22c present in the positive electrode current collector region 22g of the positive electrode mixture layer 22. Further, the positive electrode mixture layer 22 is configured such that the porosity P_{LOW} (%) of the positive electrode current collector region 22g of the positive electrode mixture layer 22 is greater than the porosity P_{UP} (%) of the separator region 22f of the positive electrode mixture layer 22.

As shown in FIG. 7, the internal resistance DC-IR (mΩ) of the lithium-ion rechargeable battery 1 was measured for Examples 2-2, 2-3, and 2-4, in which the conductive material upper-lower ratio R_{M} and the porosity upper-lower ratio R_{P} differed from one another. The aspect ratio AR, the total surface area ratio R_{S}, and the porosity P (%) were the same as Example 2.

### Example 2

In Example 2, in relation to the positive electrode active material 22b, the percentage R_{A} (mass %) was 98 mass %, the specific surface area B_{A} (BET value) (m²/g) was 2.0 m²/g, and the surface area S_{A} (m²) was 196 m². In relation to the conductive material 22c, the aspect ratio AR was 100, the percentage R_{C} (mass %) was 1.0 mass %, the specific surface area (BET value) B_{C} (m²/g) was 180 m²/g, and the surface area S_{C} (m²) was 180 m². The total surface area ratio R_{S} was 0.92. The porosity P (%) of the positive electrode mixture layer 22 was 44%. The aspect ratio AR, the total surface area ratio R_{S}, and the porosity P all satisfied the conditions of the reference values.

The conductive material upper-lower ratio R_{M} was 1.20, and the porosity upper-lower ratio R_{P} was 1.00.

That is, in Example 2, the porosity P (%) was the same in the separator region 22f and the positive electrode current collector region 22g of the positive electrode mixture layer 22. The conductive material upper-lower ratio R_{M} was 1.20. This indicates that the more particles of the conductive material 22c moved to the separator region 22f of the positive electrode mixture layer 22 than to the positive electrode current collector region 22g of the positive electrode mixture layer 22.

The internal resistance DC-IR (mΩ) of Example 2 was 490 mΩ, which was relatively satisfactory among Examples 1 to 4.

### Example 2-2

The aspect ratio AR, the total surface area ratio R_{S}, and the porosity P were the same as those of Example 2 and included in the reference value ranges. The conductive material upper-lower ratio R_{M} was 1.40, and the porosity upper-lower ratio R_{P} was 1.05. That is, as compared to Example 2, even more particles of the conductive material 22c moved to the separator region 22f of the positive electrode mixture layer 22 than to the positive electrode current collector region 22g of the positive electrode mixture layer 22. Further, as compared to Example 2, the porosity P of the positive electrode current collector region 22g of the positive electrode mixture layer 22 was greater than the porosity P (%) of the separator region 22f of the positive electrode mixture layer 22.

This means that the non-aqueous electrolyte 13 readily enters into the positive electrode current collector region 22g of the positive electrode mixture layer 22.

As a result, the internal resistance DC-IR (mΩ) of Example 2-2 was improved to 488 mΩ.

### Example 2-3

The aspect ratio AR, the total surface area ratio R_{S}, and the porosity P were the same as those of Example 2 and included in the reference value ranges. The conductive material upper-lower ratio R_{M} was 2.24, and the porosity upper-lower ratio R_{P} was 1.25. That is, as compared to Example 2-2, even more particles of the conductive material 22c have moved to the separator region 22f of the positive electrode mixture layer 22 than to the positive electrode current collector region 22g of the positive electrode mixture layer 22. Further, as compared to Example 2-2, the porosity P of the positive electrode current collector region 22g of the positive electrode mixture layer 22 was greater than the porosity P (%) of the separator region 22f of the positive electrode mixture layer 22.

This means that the conductive paths become insufficient toward the positive electrode current collector 21 in the positive electrode mixture layer 22. Thus, the internal resistance DC-IR (mΩ) is increased. In other words, when the conductive material upper-lower ratio R_{M} becomes greater, more particles of the conductive material 22c move toward the separator region 22f of the positive electrode mixture layer 22. This increases the conductive paths in the front surface side of the positive electrode mixture layer 22 and forms a conductive network between the separator region 22f of the positive electrode mixture layer 22 and the positive electrode current collector region 22g of the positive electrode mixture layer 22.

Further, this means that the non-aqueous electrolyte 13 readily enters into the positive electrode current collector region 22g of the positive electrode mixture layer 22.

As a result, the internal resistance DC-IR (mΩ) of Example 2-3 was further improved to 479 mΩ, as compared to Example 2-2.

### Example 2-4

The aspect ratio AR, the total surface area ratio R_{S}, and the porosity P were the same as those of Example 2 and included in the reference value ranges. The conductive material upper-lower ratio R_{M} was 17.75, and the porosity upper-lower ratio R_{P} was 1.70. That is, as compared to Example 2-3, even more particles of the conductive material 22c have moved to the separator region 22f of the positive electrode mixture layer 22 than to the positive electrode current collector region 22g of the positive electrode mixture layer 22. Further, as compared to Example 2-3, the porosity P of the positive electrode current collector region 22g of the positive electrode mixture layer 22 was greater than the porosity P (%) of the separator region 22f of the positive electrode mixture layer 22.

This further increases the conductive paths in the front surface side of the positive electrode mixture layer 22 and forms a conductive network between the separator region 22f of the positive electrode mixture layer 22 and the positive electrode current collector region 22g of the positive electrode mixture layer 22. Nonetheless, when the conductive material upper-lower ratio R_{M} is 17.75, the conductive material 22c is extremely biased toward the upper side (toward separator 4). In this case, the conductive material 22c is decreased at the lower side (toward positive electrode current collector 21) and the conductive paths become insufficient.

Further, this means that the non-aqueous electrolyte 13 more readily enters into the positive electrode current collector region 22g of the positive electrode mixture layer 22.

As a result, the internal resistance DC-IR (mΩ) of Example 2-4 was worsened to 481 mΩ, as compared to Example 2-3.

### Summary of Experiment 2

In Examples 2-2, 2-3, and 2-4 of Experiment 2, the aspect ratio AR, the total surface area ratio R_{S}, and the porosity P were the same as those of Example 2 and included in the reference value ranges. Only the conductive material upper-lower ratio R_{M} and the porosity upper-lower ratio R_{P} were changed for comparisons.

### Conductive Material Upper-Lower Ratio R_{M}

Example 2 had a conductive material upper-lower ratio R_{M} of 1.20. The porosity upper-lower ratio R_{P} was 1.00. That is, there was no difference in the porosity P (%) between the lower side (positive electrode current collector region 22g) and the upper side (region 22f toward separator 4). Although Experiment 2 did not include an example having the conductive material upper-lower ratio R_{M} of 1.00, it is preferred that the particles of the conductive material 22c move upward (toward separator 4). Further, the internal resistance DC-IR (mΩ) was also low at 490 mΩ.

Therefore, it is preferred that the conductive material upper-lower ratio R_{M} is 1.20 or greater.

### Porosity Upper-Lower Ratio R_{P}

The values of the conductive material upper-lower ratio R_{M} and the porosity upper-lower ratio R_{P} gradually increase in Examples 2, 2-2, 2-3, and 2-4 in this order.

However, Example 2-3 has the lowest internal resistance DC-IR (mΩ) of 479 mΩ, and Example 2-4 has a larger internal resistance DC-IR (mΩ) of 481 mΩ.

Therefore, although it is preferable that the particles of the conductive material 22c move toward the upper side (toward separator 4), the internal resistance DC-IR (mΩ) increases when the conductive material 22c is extremely biased toward the upper side (toward separator 4).

### Advantages of Present Embodiment

(1) The positive electrode plate 2 of the lithium-ion rechargeable battery 1 and the method for manufacturing the positive electrode plate 2 in accordance with the present embodiment optimize the percentages of the positive electrode active material 22b and the conductive material 22c in the positive electrode mixture layer 22 of the positive electrode plate 2 of the lithium-ion rechargeable battery 1.

An appropriate mixing ratio of the positive electrode active material 22b and the conductive material 22c reduces the internal resistance DC-IR (mΩ) of the lithium-ion rechargeable battery 1.

(2) The equation of R_{S}=(R_{C}×B_{C})/(R_{A}× B_{A}) is satisfied, where R_{C} (mass %) represents the percentage of the conductive material 22c in the positive electrode mixture, B_{C} (m²/g) represents the specific surface area (m²/g) of the conductive material 22c, R_{A} (mass %) represents the percentage of the positive electrode active material 22b in the positive electrode mixture, B_{A} (m²/g) represents the specific surface area (m²/g) of the positive electrode active material 22b, and R_{S} represents the total surface area ratio. In this case, the aspect ratio AR of the conductive material 22c is set to thirty or greater. The total surface area ratio R_{S} is set in a range of 0.2 to 1.93. The porosity P (%) is set in a range of 40% to 55%.

Thus, well-balanced percentages of the surface area (m²) of the positive electrode active material 22b and the surface area (m²) of the conductive material 22c are obtained taking into consideration the aspect ratio AR of the conductive material 22c and the porosity P (%) of the positive electrode mixture layer 22.

(3) The total surface area ratio R_{S} is set in a range of 0.92 to 1.93, the specific surface area B_{A} (m²/g) of the positive electrode active material is set in a range of 1.6 to 2.0 m²/g, and the specific surface area B_{C} (m²/g) of the conductive material 22c is set in a range of 180 to 500 m²/g. Further, the percentage R_{C} of the conductive material 22c in the positive electrode mixture is set in a range of 1.0 to 1.5 mass %.

Thus, the percentages of the surface area (m²) of the positive electrode active material 22b and the surface area (m²) the conductive material 22c are readily optimized.

(4) The positive electrode mixture layer 22 of the positive electrode plate 2 is divided in the thickness-wise direction of the positive electrode mixture layer 22 into two regions, the separator region 22f and the positive electrode current collector region 22g. Further, the mass M_{UP} (g) of the conductive material 22c present in the separator region 22f of the positive electrode mixture layer 22 is set to be greater than the mass M_{LOW} (g) of the conductive material 22c present in the positive electrode current collector region 22g of the positive electrode mixture layer 22.

Thus, a sufficient amount of the conductive material 22c forms an effective conductive network in the separator region 22f of the positive electrode mixture layer 22.

In particular, the internal resistance DC-IR (mΩ) is further reduced when the conductive material upper-lower ratio R_{M}, which is the mass ratio of the mass M_{UP} (g) of the conductive material 22c present in the separator region 22f of the positive electrode mixture layer 22 to the mass M_{LOW} (g) of the conductive material 22c present in the positive electrode current collector region 22g of the positive electrode mixture layer 22, is set in a range of 1.5 to 20.

(5) The porosity P_{LOW} (%) of the positive electrode current collector region 22g of the positive electrode mixture layer 22 is set to be greater than the porosity P_{UP} (%) of the separator region 22f of the positive electrode mixture layer 22.

Thus, a sufficient volume of voids in the positive electrode current collector region 22g of the positive electrode mixture layer 22 facilitates the diffusion of the non-aqueous electrolyte 13 into the positive electrode active material of Li ions.

In particular, the internal resistance DC-IR (mΩ) is further reduced when the porosity upper-lower ratio R_{P}, which is the ratio of the P_{LOW} (%) of the positive electrode current collector region 22g of the positive electrode mixture layer 22 to the porosity P_{UP} (%) of the separator region 22f of the positive electrode mixture layer 22, is set in a range of 1.1 to 12.

(6) The solid content ratio NV of the positive electrode mixture paste 22a is adjusted in the positive electrode mixture paste preparation step (S1), and the drying temperature and the drying time period are controlled in the first drying step (S3) and the second drying step (S5).

Thus, the conductive material upper-lower ratio R_{M} and the porosity upper-lower ratio R_{P} are controlled to intended numerical values using the effect of migration.

### Modified Examples

The above embodiment is an example of the present invention, and can be modified and implemented as follows.

The numerical values and ranges are merely examples, and can be optimized by one skilled in the art.

In the present embodiment, the conductive material upper-lower ratio R_{M} and the porosity upper-lower ratio R_{P} are specified. However, the conductive material upper-lower ratio R_{M} and the porosity upper-lower ratio R_{P} are optional configurations, each of which can be combined with the aspect ratio AT, the total surface area ratio R_{S}, and the porosity P (%).

In the present embodiment, the positive electrode mixture layer 22 is formed on both surfaces of the positive electrode current collector 21 so that the present disclosure is implemented on both surfaces. However, the present disclosure may be implemented on the positive electrode current collector 21 on only one surface.

In the present embodiment, the lithium-ion rechargeable battery 1 is described as an example of a non-aqueous electrolyte rechargeable battery that is a plate-shaped battery cell to be mounted on a vehicle. However, the non-aqueous electrolyte rechargeable battery is not limited to such a structure and may be cylindrical and/or stationary. Further, the electrode body 12 is not limited to a flat roll type and may be a stack of rectangular plate-shaped electrodes. In addition, there is no limitation to the shapes of the positive electrode external terminal 14 and the negative electrode external terminal 15.

The drawings are provided to illustrate the present embodiment, and depiction of elements may be exaggerated for clarity. Thus, the present disclosure is not limited to the drawings.

The flowchart shown in FIG. 4 is an example of the present disclosure. Other steps may be added or some of the steps may be deleted. Further, the steps may be performed in any order. For example, a pressing step may be added between the first drying step (S3) and the back-surface positive electrode mixture paste application step (S4).

The composition, material characteristics, and the like of the positive electrode mixture paste 22a are examples of the present disclosure, and can be optimized by one skilled in the art.

The present embodiment is an embodiment of the present disclosure. It should be apparent to one skilled in the art that the present disclosure is not limited to the embodiment and can be implemented by adding, deleting, or changing the structure without departing from the scope of the claims.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A positive electrode plate for a non-aqueous electrolyte rechargeable battery, the battery including a positive electrode plate, a negative electrode plate, a separator insulating the positive electrode plate and the negative electrode plate, and a non-aqueous electrolyte, the positive electrode plate comprising:
a positive electrode current collector; and
a positive electrode mixture layer formed on a part of at least one surface of the positive electrode current collector and formed by a positive electrode mixture, the positive electrode mixture including a positive electrode active material and a conductive material,
wherein when R_{S}=(R_{C}×B_{C})/(R_{A}×B_{A}) is satisfied, where R_{C} (mass %) represents a percentage of the conductive material in the positive electrode mixture, B_{C} (m²/g) represents a specific surface area of the conductive material, R_{A} (mass %) represents a percentage of the positive electrode active material in the positive electrode mixture, B_{A} (m²/g) represents a specific surface area of the positive electrode active material, and R_{S} represents a total surface area ratio,
an aspect ratio AR of the conductive material is thirty or greater;
the total surface area ratio R_{S} is in a range of 0.20 to 1.93; and
a porosity P (%) of the positive electrode mixture layer is in a range of 40% to 55%.

2. The positive electrode plate according to claim 1, wherein
the specific surface area B_{A} (m²/g) of the positive electrode active material is in a range of 1.6 to 3.3 m²/g,
the specific surface area B_{C} (m²/g) of the conductive material is in a range of 180 to 500 m²/g, and
the percentage R_{C} (mass %) of the conductive material in the positive electrode mixture is in a range of 0.2 to 1.5 mass %.

3. The positive electrode plate according to claim 1, wherein:
the positive electrode mixture layer is divided in a thickness-wise direction of the positive electrode mixture layer into two regions, a separator region located closer to the separator, and a positive electrode current collector region located closer to the positive electrode current collector; and
a mass M_{UP} (g) of the conductive material present in the separator region of the positive electrode mixture layer is greater than a mass M_{LOW} (g) of the conductive material present in the positive electrode current collector region of the positive electrode mixture layer.

4. The positive electrode plate according to claim 3, wherein a conductive material upper-lower ratio R_{M} is in a range of 1.5 to 20, where the conductive material upper-lower ratio R_{M} is a mass ratio of the mass M_{UP} (g) of the conductive material present in the separator region of the positive electrode mixture layer to the mass M_{LOW} (g) of the conductive material present in the positive electrode current collector region of the positive electrode mixture layer.

5. The positive electrode plate according to claim 3, wherein a porosity P_{LOW} (%) of the positive electrode current collector region of the positive electrode mixture layer is greater than a porosity P_{UP} (%) of the separator region of the positive electrode mixture layer.

6. The positive electrode plate according to claim 5, wherein a porosity upper-lower ratio R_{P} is in a range of 1.1 to 12, where the porosity upper-lower ratio R_{P} is a ratio of the P_{LOW} (%) of the positive electrode current collector region of the positive electrode mixture layer to the P_{UP} (%) of the separator region of the positive electrode mixture layer.

7. A non-aqueous electrolyte rechargeable battery, the battery comprising:
the positive electrode plate for a non-aqueous electrolyte rechargeable battery according to claim 1.

8. A method for manufacturing a positive electrode plate for a non-aqueous electrolyte rechargeable battery, the battery including a positive electrode plate, a negative electrode plate, a separator insulating the positive electrode plate and the negative electrode plate, and a non-aqueous electrolyte, wherein the positive electrode plate includes a positive electrode current collector and a positive electrode mixture layer, the positive electrode mixture layer being formed on a part of at least one surface of the positive electrode current collector and formed by a positive electrode mixture, and the positive electrode mixture including a positive electrode active material and a conductive material, the method comprising:
preparing a positive electrode mixture paste;
applying the positive electrode mixture paste to a part of at least one surface of the positive electrode current collector; and
drying the positive electrode mixture paste to form the positive electrode mixture layer, wherein:
the preparing a positive electrode mixture paste is performed so that when R_{S}=(R_{C}×B_{C})/(R_{A}×B_{A}) is satisfied, where R_{C} (mass %) represents a percentage of the conductive material in the positive electrode mixture, B_{C} (m²/g) represents a specific surface area of the conductive material, R_{A} (mass %) represents a percentage of the positive electrode active material in the positive electrode mixture, B_{A} (m²/g) represents a specific surface area of the positive electrode active material, and R_{S} represents a total surface area ratio,
an aspect ratio AR of the conductive material is thirty or greater;
the total surface area ratio R_{S} is in a range of 0.20 to 1.93; and
a porosity P (%) of the positive electrode mixture layer is in a range of 40% to 55%.

9. The method according to claim 8, the positive electrode mixture layer being divided in a thickness-wise direction of the positive electrode mixture layer into two regions, a separator region located closer to the separator, and a positive electrode current collector region located closer to the positive electrode current collector, wherein:
the preparing a positive electrode mixture paste includes adjusting a solid content ratio NV of the positive electrode mixture paste, and the drying the positive electrode mixture paste includes controlling a drying temperature and a drying time period so that:
a conductive material upper-lower ratio R_{M} after the drying is in a range of 1.5 to 20, where the conductive material upper-lower ratio R_{M} is a mass ratio of a mass M_{UP} (g) of the conductive material present in the separator region of the positive electrode mixture layer to a mass M_{LOW} (g) of the conductive material present in the positive electrode current collector region of the positive electrode mixture layer; and
a porosity upper-lower ratio R_{P} is in a range of 1.1 to 12, where the porosity upper-lower ratio R_{P} is a ratio of a porosity P_{LOW} (%) of the positive electrode current collector region of the positive electrode mixture layer to a porosity P_{UP} (%) of the separator region of the positive electrode mixture layer.
